(19) United States
(12) Patent Application Publication
(10) Pub. No.: US 2003/0224666 A1
(43) Pub. Date: Dec. 4, 2003

(54) Modular Plug

(76) Inventor: Peng Yuan-Huei, Shen Keng Shiang (TW)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/404,263

(22) Filed: Apr. 1, 2003

(30) Foreign Application Priority Data
May 30, 2002 (TW) 091207954

(51) Int. Cl. H01R 24/00

(52) U.S. Cl. 439/676

(57) ABSTRACT

A modular plug for connecting a socket and transmitting a signal is provided. The modular plug includes: a plug housing for being mounted on the socket, a distributor mounted in the plug housing, a first communication medium mounted in the distributor and having a first wire direction thereof, and a second communication medium mounted in the distributor and having a second wire direction thereof, wherein a first intersecting angle is formed between the first wire direction and the second wire direction for reducing an attenuation value of the signal transmitted by the modular plug.

### FIELD OF THE INVENTION

The present invention is related to a modular plug, and more particularly, to a modular plug for connecting a socket and transmitting a signal.

### BACKGROUND OF THE INVENTION

Generally, a modular plug for transmitting internet signals is connected to a keystone Jack or a keystone panel. Please refer to FIG. 1. FIG. 1 is a diagram illustrating the common keystone Jack according to the prior art. The keystone Jack 10 is mounted in the frame 11. Please refer to FIG. 2. FIG. 2 is a diagram illustrating the conventional modular plug according to the prior art. The keystone Jack 10 in FIG. 1 is able to be connected with the modular plug 20. Inside the modular plug 20, the 8 wires 21 are parallel to each other and tightly aligned, which forms a plane 22. Although such wire arrangement is easy for manufacturing, it has other disadvantages. When data is transmitted at high transmission rates, each wire pair both transmits and receives electromagnetic radiation so that the signals flowing through the wire pair may couple with the signals flowing through another wire pair. The unintended electromagnetic coupling of signals between different wire pairs is called crosstalk, which is a source of interference that often adversely affects the processing of these signals. As shown in FIG. 2, the distance between the wire 23 and the neighbor wire 24 is too close to avoid a high crosstalk when transmitting internet signals. Please refer to FIG. 3(a). FIG. 3(a) is a diagram illustrating another conventional modular plug according to the prior art. The modular plug 30 has a different wire arrangement. The wire 23 is mounted in the first communication medium 31 and the neighbor wire 24 is mounted in the second communication medium 32. Furthermore, the modular plug 30 has the third communication medium 33 and the protruding portion 301. Apparently, a longer distance LD is formed between the communication mediums 31 and 32, which reduces the attenuation value of the signal transmitted by the modular plug 30. However, since the 8 wires inside the modular plug 30 are still parallel to each other, the attenuation value of signals is still too high when transmitting the internet signals.

Please refer to FIG. 3(b). FIG. 3(b) is a side view illustrating the conventional modular plug according to FIG. 3(a) of the present invention. Inside the modular plug 30, the first communication medium 31 and second communication medium 32 are parallel to each other between the length PL, which usually has a length of 5 mm. Due to the fact that the first communication medium 31 and the second communication medium 32 maintain their parallel statuses, the attenuation value of signals could not be significantly improved when transmitting the internet signals. Please refer to FIGS. 4-6. FIG. 4 is a diagram illustrating the conventional distributor inside the modular plug according to the prior art. The distributor 40 is used for mounting the 8 wires therein, which are arranged by another different wire arrangement. FIG. 5 is a diagram illustrating the conventional modular plug for the distributor of FIG. 4 according to the present invention. FIG. 6 is a diagram illustrating the conventional wire pairs inside the cable according to the prior art. The distributor 40 in FIG. 4 is used for being mounted inside the modular plug 50. The 8 wires 60 inside the cable 61 are divided into 4 wire pairs and separated by the cross-shaped partition 63. The 8 wires 60 are covered by the covering 62 of the cable 61. The distributor 40 in FIG. 4 is used for mounting the 8 wires 60 therein. However, the 8 wires 60 are still parallel to each other inside the distributor 40, which is not able to significantly reduce the attenuation value of signals either. Besides, since the 8 wires 60 inside the distributor 40 are parallel to each other, the uncovered portion (as shown in FIG. 6) of the cable 61 is too long for the modular plug 50 with a short body, which will lower the performance. Another arrangement for the 8 wires 60 is to arrange 4 wires on the upper plane and the other 4 wires on the lower plane. However, this kind of manufacturing is more difficult and costs higher.

From the above description, it is known that the parallel arrangement of the wires causes the attenuation of the transmitted internet signals. Therefore, how to reduce the attenuation value of signals by a simple manufacturing method has become a major problem waited to be solved in the industry. In order to overcome the drawbacks in the prior art, a modular plug is provided. The particular design in the present invention not only solves the problem that the wires are parallel to each other inside the modular plug, but also reduces the attenuation value of signals significantly. Moreover, the manufacturing process is easy and economical to be executed. Thus, the invention has the utility for the industry.

### SUMMARY OF THE INVENTION

The main purpose of the present invention is to provide a modular plug, which is able to reduce the attenuation value of signals when transmitting the internet signals by producing an intersecting angle between the first communication medium and the second communication medium so that the wires inside the distributor are not parallel to each other.

It is one object of the present invention to provide a modular plug with a distributor, which has a cross-shaped extended board mounted therein for easily connecting with the cross-shaped partition inside the cable.

It is another object of the present invention to provide a modular plug, which reduces the length of the uncovered portion of the cable when the 8 wires are mounted in a modular plug with a short body due to the fact that the first communication medium is not parallel to the second communication medium.

According to one aspect of the present invention, a modular plug for connecting a socket and transmitting a signal, comprises: a plug housing for being mounted on the socket, a distributor mounted in the plug housing, a first communication medium mounted in the distributor and having a first wire direction thereof, and a second communication medium mounted in the distributor and having a second wire direction thereof, wherein a first intersecting angle is formed between the first wire direction and the second wire direction for reducing an attenuation value of the signal transmitted by the modular plug.

In accordance with the present invention, the modular plug further comprises a third communication medium having a third wire direction thereof and a fourth communication medium having a fourth wire direction thereof.

Preferably, a second intersecting angle is formed between the first wire direction and the third wire direction.

Preferably, the first intersecting angle is smaller than the second intersecting angle.

Preferably, a third intersecting angle is formed between the first wire direction and the fourth wire direction.

Preferably, the first intersecting angle is smaller than the third intersecting angle.

Preferably, the first communication medium, the second communication medium, the third communication medium and the fourth communication medium are used for respectively mounting a first wire pair, a second wire pair, a third wire pair, and a fourth wire pair.

Preferably, the first wire pair, the second wire pair, the third wire pair, and the fourth wire pair are distributed from a cable for transmitting four different signal pairs of the signal.

Preferably, the cable further comprises a cross-shaped partition for separating the first wire pair, the second wire pair, the third wire pair, and the fourth wire pair.

Preferably, the distributor further comprises a cross-shaped extended board for connecting the cross-shaped partition of the cable.

Preferably, the cross-shaped extended board has an arc end for facilitating to be fitted in the distributor.

According to another aspect of the present invention, a modular plug for connecting a socket and transmitting a signal, comprises: a plug housing for being mounted on the socket, a distributor mounted in the plug housing, wherein the distributor further comprises a first communication medium mounted therein and having a first wire direction thereof; and a second communication medium mounted therein and having a second wire direction thereof, and wherein a first intersecting angle is formed between the first wire direction and the second wire direction for reducing an attenuation value of the signal transmitted by the modular plug.

The foregoing and other features and advantages of the present invention will be more clearly understood through the following descriptions with reference to the drawings, wherein:

### BRIEF DESCRIPTION OF THE DRAWINGS

FIG. 1 is a diagram illustrating the common keystone Jack according to the prior art;

FIG. 2 is a diagram illustrating the conventional modular plug according to the prior art;

FIG. 3(a) is a diagram illustrating another conventional modular plug according to the prior art;

FIG. 3(b) is a side view illustrating the conventional modular plug according to FIG. 3(a) of the present invention;

FIG. 4 is a diagram illustrating the conventional distributor inside the modular plug according to the prior art;

FIG. 5 is a diagram illustrating the conventional modular plug for the distributor of FIG. 4 according to the present invention;

FIG. 6 is a diagram illustrating the conventional wire pairs inside the cable according to the prior art;

FIG. 7 is a diagram illustrating the structure of the modular plug according to a preferred embodiment of the present invention;

FIG. 8(a) is a diagram illustrating the structure of the distributor of the modular plug according to a preferred embodiment of the present invention;

FIG. 8(b) is a diagram illustrating the wire pairs mounted in the distributor of the modular plug according to a preferred embodiment of the present invention;

FIG. 9 is a diagram illustrating the modular plug according to a preferred embodiment of the present invention; and

FIG. 10 is a diagram illustrating the distributor used for the modular plug with a short body according to another preferred embodiment of the present invention.

### DETAILED DESCRIPTION OF THE PREFERRED EMBODIMENT

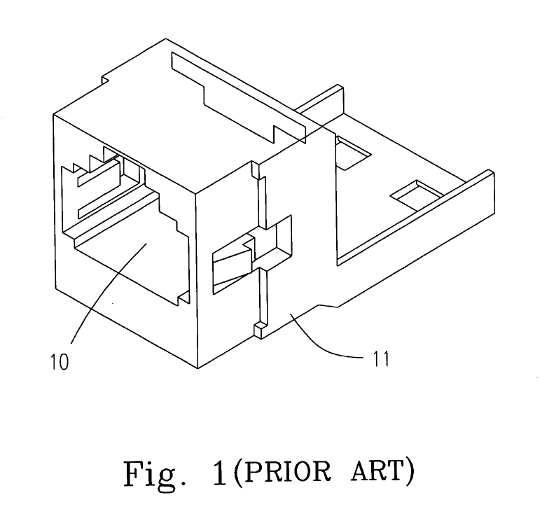

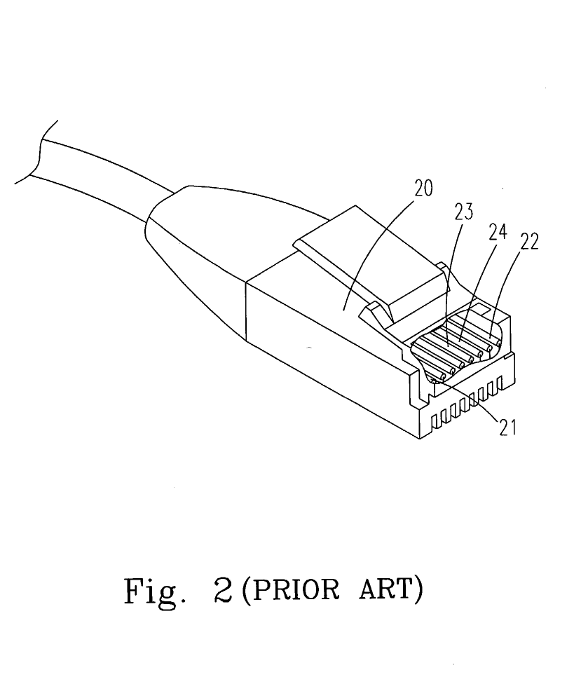

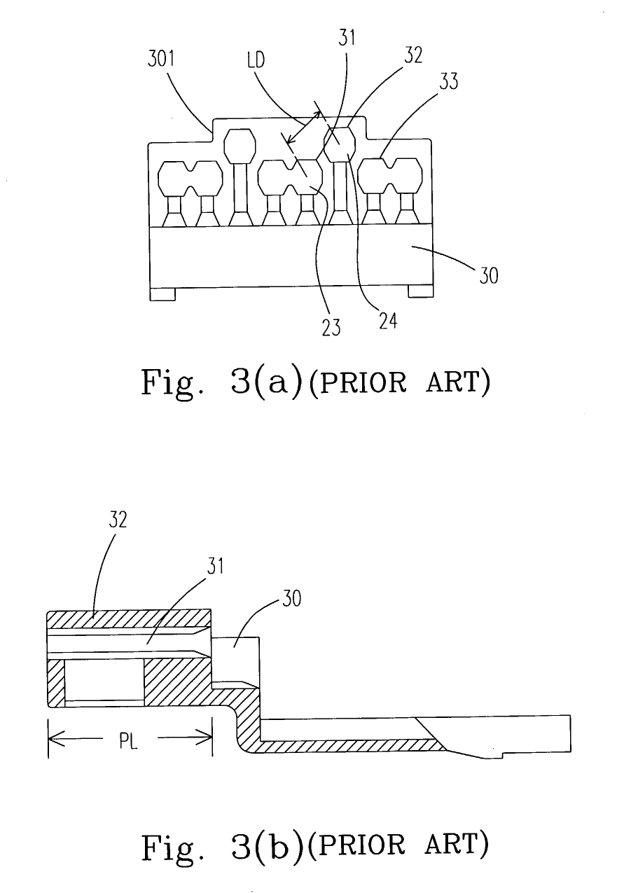

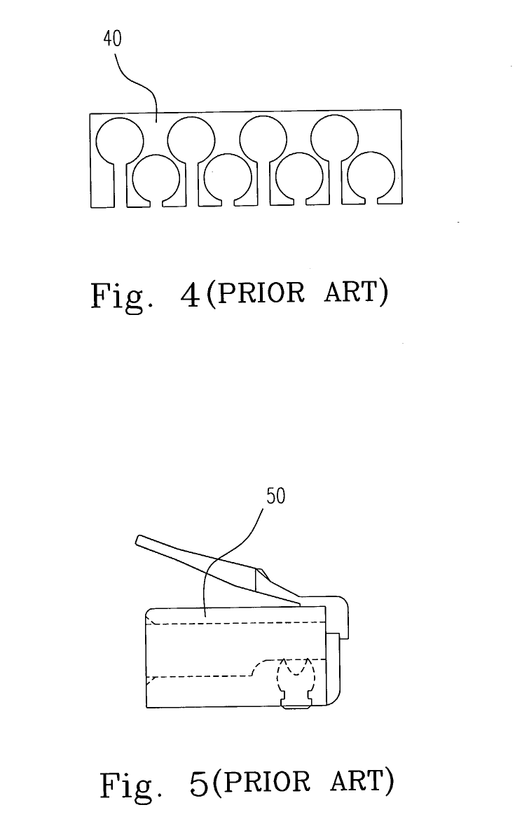

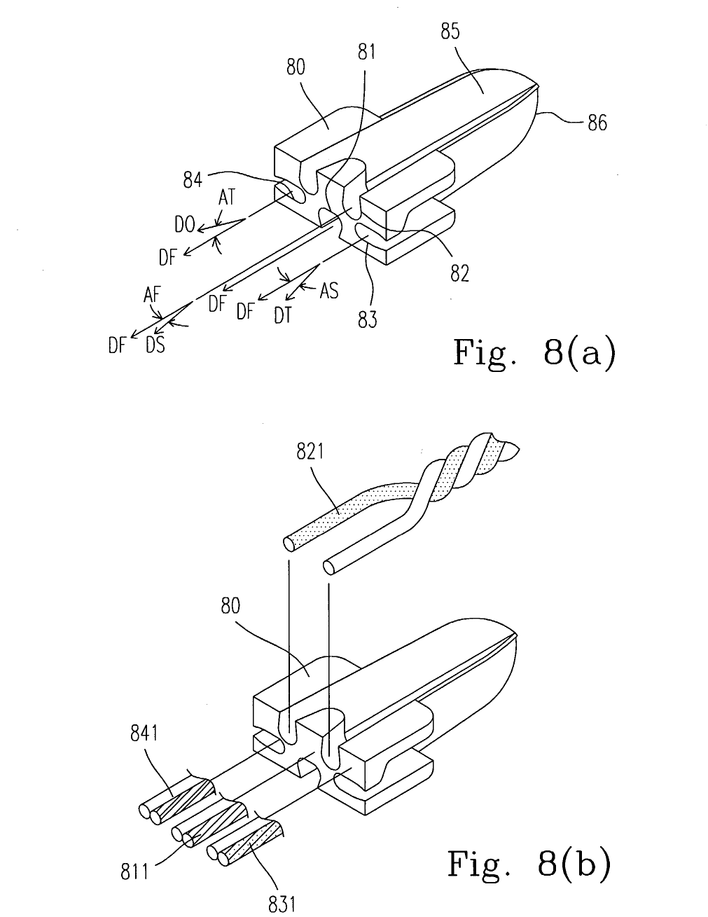

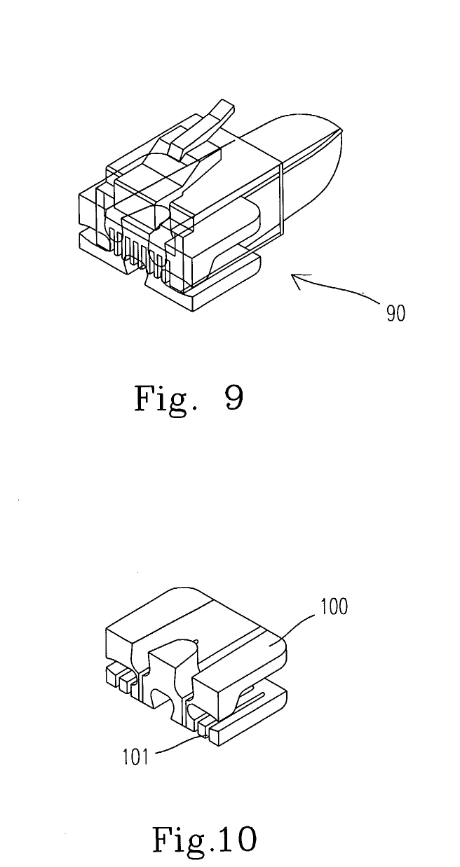

The present invention will now described more specifically with reference to the following embodiments. Please refer to FIGS. 7-9. FIG. 7 is a diagram illustrating the structure of the modular plug according to a preferred embodiment of the present invention. The modular plug 70 is used for connecting with the keystone Jack (as shown in FIG. 1) when transmitting the internet signals. Please refer to FIG. 8(a). FIG. 8(a) is a diagram illustrating the structure of the distributor of the modular plug according to a preferred embodiment of the present invention. The modular plug 70 includes the plug housing 71 and the distributor 80. The plug housing 71 is used for being mounted on the socket (keystone Jack). Please refer to FIG. 9. FIG. 9 is a diagram illustrating the modular plug according to a preferred embodiment of the present invention. The distributor 80 is mounted in the plug housing 71, which forms the modular plug 90 of the present invention. A first communication medium 81 is mounted in the distributor 80 and has a first wire direction DF as shown in FIG. 8(a). A second communication medium 82 is mounted in the distributor 80 and has a second wire direction DS as shown in FIG. 8(a). Therefore, a first intersecting angle AF is formed between the first wire direction DF and the second wire direction DS. Since the wires are not parallel to each other, the attenuation value of signals transmitted by the modular plug 90 will be reduced.

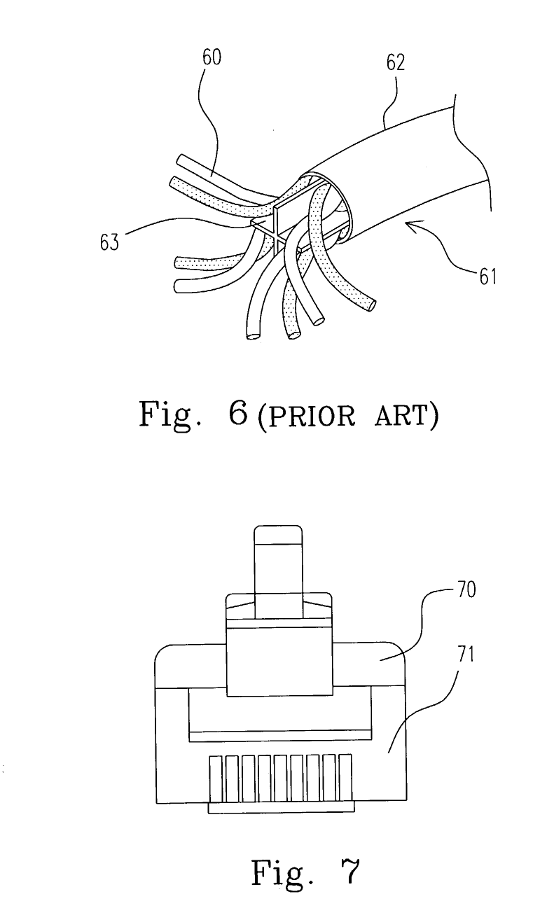

Furthermore, the distributor 80 includes a third communication medium 83 which has a third wire direction DT as shown in FIG. 8(a), and a fourth communication medium 84 which has a fourth wire direction DO as shown in FIG. 8(a). Therefore, a second intersecting angle AS is formed between the first wire direction DF and the third wire direction DT. A third intersecting angle AT is formed between the first wire direction DF and the fourth wire direction DO. The first intersecting angle AF is smaller than the second intersecting angle AS, and the first intersecting angle AF is smaller than the third intersecting angle AT. Please refer to FIG. 8(b). FIG. 8(b) is a diagram illustrating the wire pairs mounted in the distributor of the modular plug according to a preferred embodiment of the present invention. The first communication medium 81, the second communication medium 82, the third communication medium 83 and the fourth communication medium 84 are used for respectively mounting a first wire pair 811, a second wire pair 821, a third wire pair 831, and a fourth wire pair 841. The first wire pair 811, the second wire pair 821, the third wire pair 831, and the fourth wire pair 841 are distributed from the cable 61 (shown in FIG. 6) for transmitting four different signal pairs of the internet signals. According to a preferred embodiment of the present invention, the cable 61 (shown in FIG. 6) further includes a cross-shaped partition 63 for separating the first wire pair 811, the second wire pair 821, the third wire pair 831, and the fourth wire pair 841. Moreover, the distributor 80 further includes a cross-shaped extended board 85 (not shown in drawings) inside the distributor 80 for connecting the cross-shaped partition 63 of the cable 61.

The cross-shaped extended board 85 has an arc end for facilitating to be fitted in the distributor 80, which also helps the manufacturing process. Please refer to FIG. 10. FIG. 10 is a diagram illustrating the distributor used for the modular plug with a short body according to another preferred embodiment of the present invention. According to another preferred embodiment of the present invention, the distributor 80 shown in FIG. 8(a) could be changed into the distributor 100 with a short body, which has no cross-shaped extended board 85 inside so that it would be fitted in the modular plug with a short body. Besides, the uncovered portion of the cable 61 (as shown in FIG. 6) can be shorter by using the modular plug with a short body. The 8 narrow channels 101 are mounted inside the distributor 100 for the 8 conductive pieces (not shown) passing through so that the 8 wires 60 (as shown in FIG. 6) are electrically connected to these 8 conductive pieces to transmit the signals.

According to the above, the drawbacks in the conventional modular plug do not exist in the modular plug provided in the present invention. First, the four communication mediums have different directions, which generate different intersecting angles. Therefore, the wire pairs are mounted and arranged in different directions. Since the wires are not parallel to each other, the attenuation value of signals transmitted by the modular plug is significantly reduced. Furthermore, the distributor of the present invention includes the cross-shaped extended board for facilitating the connection between the wires in the distributor and the wires in the cross-shaped partition of the cable so that the four wire pairs are clearly separated when transmitting the signals. Hence, the present invention not only has a novelty and a progressive nature, but also has an industry utility.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A modular plug for connecting a socket and transmitting a signal, comprising:
a plug housing for being mounted on said socket;
a distributor mounted in said plug housing;
a first communication medium mounted in said distributor and having a first wire direction thereof; and
a second communication medium mounted in said distributor and having a second wire direction thereof, wherein a first intersecting angle is formed between said first wire direction and said second wire direction for reducing an attenuation value of said signal transmitted by said modular plug.

2. The modular plug according to claim 1 further comprising a third communication medium having a third wire direction thereof and a fourth communication medium having a fourth wire direction thereof.

3. The modular plug according to claim 2, wherein a second intersecting angle is formed between said first wire direction and said third wire direction.

4. The modular plug according to claim 3, wherein said first intersecting angle is smaller than said second intersecting angle.

5. The modular plug according to claim 2, wherein a third intersecting angle is formed between said first wire direction and said fourth wire direction.

6. The modular plug according to claim 5, wherein said first intersecting angle is smaller than said third intersecting angle.

7. The modular plug according to claim 2, wherein said first communication medium, said second communication medium, said third communication medium and said fourth communication medium are used for respectively mounting a first wire pair, a second wire pair, a third wire pair, and a fourth wire pair.

8. The modular plug according to claim 7, wherein said first wire pair, said second wire pair, said third wire pair, and said fourth wire pair are distributed from a cable for transmitting four different signal pairs of said signal.

9. The modular plug according to claim 8, wherein said cable further comprises a cross-shaped partition for separating said first wire pair, said second wire pair, said third wire pair, and said fourth wire pair.

10. The modular plug according to claim 9, wherein said distributor further comprises a cross-shaped extended board for connecting said cross-shaped partition of said cable.

11. The modular plug according to claim 10, wherein said cross-shaped extended board has an arc end for facilitating to be fitted in said distributor.

12. A modular plug for connecting a socket and transmitting a signal, comprising:
a plug housing for being mounted on said socket;
a distributor mounted in said plug housing, wherein said distributor further comprises a first communication medium mounted therein and having a first wire direction thereof; and a second communication medium mounted therein and having a second wire direction thereof, and wherein a first intersecting angle is formed between said first wire direction and said second wire direction for reducing an attenuation value of said signal transmitted by said modular plug.
